(19) United States
(12) Patent Application Publication
(10) Pub. No.: US 2025/0381574 A1
(43) Pub. Date: Dec. 18, 2025

(54) CHEMICAL LIQUID SUPPLY DEVICE, CLEANING SYSTEM AND LIQUID SUPPLY METHOD

(71) Applicant: EBARA CORPORATION, Tokyo (JP)

(72) Inventors: FUJIHIKO TOYOMASU, Tokyo (JP); KENICHIRO SAITO, Tokyo (JP)

(73) Assignee: EBARA CORPORATION, Tokyo (JP)

(21) Appl. No.: 19/231,575

(22) Filed: Jun. 9, 2025

(30) Foreign Application Priority Data
Jun. 13, 2024 (JP) 2024-095873

(51) Int. Cl. B05B 12/14; B08B 3/02; B08B 13/00

(52) U.S. Cl. CPC B05B 12/14; B08B 3/02; B08B 13/00

(57) ABSTRACT

Provided is a chemical liquid supply device including: a junction point; a dilution water pipe; a first chemical liquid pipe; a second chemical liquid pipe; a first valve; a second valve; a third valve; a cleaning chemical liquid supply pipe; and a control device operable in first to fifth modes. The control device controls the first valve, the second valve, and the third valve such that in the first mode, only the first chemical liquid is supplied to the external device, in the second mode, only the second chemical liquid is supplied to the external device, in the third mode, a first cleaning chemical liquid is supplied to the external device, in the fourth mode, a second cleaning chemical liquid is supplied to the external device, and in the fifth mode, a third cleaning chemical liquid is supplied to the external device.

### CROSS-REFERENCE TO RELATED APPLICATION

This application claims the priority benefits of Japanese application No. 2024-095873, filed on Jun. 13, 2024. The entirety of the above-mentioned patent application is hereby incorporated by reference herein and made a part of this specification.

### BACKGROUND

### Technical Field

The disclosure relates to a chemical liquid supply device, a cleaning system, and a liquid supply method.

### Description of Related Art

In a semiconductor manufacturing process, a CMP (chemical mechanical polishing) device is used to planarize a substrate surface. The CMP device can include a polishing device for polishing the surface of the substrate and a cleaning device for cleaning the substrate. Then, the cleaning device is connected to the chemical liquid supply device. The chemical liquid supply device supplies the cleaning liquid to the cleaning device. For example, Patent Literature 1 (Japanese Patent Application Laid-Open (JP-A) No. 2017-216483) discloses an example of the chemical liquid supply device.

The cleaning liquid supply device (chemical liquid supply device) disclosed in Patent Literature 1, as shown in FIG. 3 thereof, includes a pure water supply line 50, an ammonia water supply line 52, a hydrogen peroxide solution supply line 54, a junction point M, and a cleaning liquid supply line 68. Then, at the junction point M, pure water flowing through the pure water supply line 50, ammonia water flowing through the ammonia water supply line 52, and hydrogen peroxide solution flowing through the hydrogen peroxide solution supply line 54 join together to generate a cleaning liquid. The cleaning liquid supply line 68 is configured to supply the generated cleaning liquid to the substrate. With such a configuration, the cleaning liquid supply device can generate an SC-1 cleaning liquid, which is a mixed liquid of ammonia water and hydrogen peroxide solution diluted with pure water, and supply this cleaning liquid to the cleaning liquid supply nozzles 34 and 38. In other words, Patent Literature 1 discloses a cleaning liquid supply device that can supply a cleaning liquid, which is made by diluting any two types of chemical liquids with pure water, to a nozzle.

With recent advances in semiconductor technology, there is a demand to reduce the wiring width formed on the surface of a semiconductor substrate. In order to form finer wiring on the surface of the semiconductor substrate, it becomes necessary to remove smaller particles adhering to the substrate surface, and the development of a cleaning process for removing such small particles is required. The size of particles that a cleaning device can remove is considered to change according to the type, concentration, flow rate, and the like of the cleaning chemical liquid. Thus, a chemical liquid supply device capable of supplying various types of liquids to the nozzle for cleaning the surface of the semiconductor substrate may be necessary for the development of the cleaning process. Further, in the cleaning process, cleaning not only the front surface but also the back surface of the semiconductor substrate may be necessary in some cases. Thus, a device capable of supplying various types of liquids to the nozzle for cleaning the back surface of the semiconductor substrate may also be necessary for the development of the cleaning process.

As described above, Patent Literature 1 discloses a cleaning liquid supply device that can supply a cleaning liquid, which is made by diluting any two types of chemical liquids with pure water, to a nozzle. However, since the development of recent cleaning processes requires a chemical liquid supply device capable of supplying various types of liquids, there is a possibility that the function of the cleaning liquid supply device of Patent Literature 1 may be insufficient. In other words, a chemical liquid supply device capable of supplying liquids other than the cleaning liquid obtained by diluting any two types of chemical liquids with pure water to external devices such as nozzles is required.

Thus, an object of the disclosure is to provide a chemical liquid supply device, a cleaning system, and a liquid supply method capable of supplying liquids other than a cleaning liquid obtained by diluting any two types of chemical liquids with pure water to an external device.

### SUMMARY

A chemical liquid supply device according to the disclosure is a chemical liquid supply device for supplying a supply liquid to an external device, and includes: a junction point; a dilution water pipe for supplying water to the junction point; a first chemical liquid pipe for supplying a first chemical liquid to the junction point; a second chemical liquid pipe for supplying a second chemical liquid to the junction point; a first valve attached to the dilution water pipe; a second valve attached to the first chemical liquid pipe; a third valve attached to the second chemical liquid pipe; a cleaning chemical liquid supply pipe located downstream of the junction point, for supplying the supply liquid to the external device; and a control device operable in a first mode, a second mode, a third mode, a fourth mode, and a fifth mode. The control device controls the first valve, the second valve, and the third valve such that in the first mode, only the first chemical liquid is supplied to the external device as the supply liquid, in the second mode, only the second chemical liquid is supplied to the external device as the supply liquid, in the third mode, a first cleaning chemical liquid formed by mixing the first chemical liquid and the water is supplied to the external device as the supply liquid, in the fourth mode, a second cleaning chemical liquid formed by mixing the second chemical liquid and the water is supplied to the external device as the supply liquid, and in the fifth mode, a third cleaning chemical liquid formed by mixing the first chemical liquid, the second chemical liquid, and the water is supplied to the external device as the supply liquid.

A cleaning system according to the disclosure is a cleaning system, and includes: the chemical liquid supply device; and a substrate cleaning device for cleaning a substrate. The cleaning chemical liquid supply pipe has an upstream pipe constituting a flow path from the junction point to a branch point, a first pipe constituting a flow path from the branch point to a first nozzle, and a second pipe constituting a flow path from the branch point to a second nozzle. The substrate cleaning device has the first nozzle and the second nozzle. The first nozzle is configured to supply the supply liquid to a first surface of the substrate, and the second nozzle is configured to supply the supply liquid to a second surface on a back side of the first surface of the substrate.

A liquid supply method according to the disclosure is a liquid supply method using the chemical liquid supply device, and includes: a process in which the chemical liquid supply device supplies at least one of the first chemical liquid, the second chemical liquid, the first cleaning chemical liquid, the second cleaning chemical liquid, and the third cleaning chemical liquid to the external device.

### BRIEF DESCRIPTION OF THE DRAWINGS

FIG. 1A is a fluid circuit diagram of a cleaning system according to an embodiment of the disclosure.

FIG. 1B is a fluid circuit diagram illustrating the substrate cleaning device of FIG. 1A in detail.

FIG. 2 is a schematic front view illustrating the chemical liquid supply device of FIG. 1A.

FIG. 3 is a fluid circuit diagram illustrating the configuration of the flow control device.

FIG. 4A is a time chart illustrating the opening/closing timing of each valve during operation of the control device in a first mode.

FIG. 4B is a time chart illustrating the opening/closing timing of each valve during operation of the control device in a second mode.

FIG. 4C is a time chart illustrating the opening/closing timing of each valve during operation of the control device in a third mode.

FIG. 4D is a time chart illustrating the opening/closing timing of each valve during operation of the control device in a fourth mode.

FIG. 4E is a time chart illustrating the opening/closing timing of each valve during operation of the control device in a fifth mode.

FIG. 5A is a time chart illustrating the opening/closing timing of each valve during operation of the control device in a first flushing mode.

FIG. 5B is a time chart illustrating the opening/closing timing of each valve during operation of the control device in a second flushing mode.

FIG. 5C is a time chart illustrating the opening/closing timing of each valve during operation of the control device in a third flushing mode.

FIG. 6 is a fluid circuit diagram of a cleaning system according to another embodiment of the disclosure.

### DESCRIPTION OF THE EMBODIMENTS

Hereinafter, embodiments of the disclosure are described with reference to the drawings. In the drawings described below, the same or equivalent components are denoted by the same reference numerals, and duplicate descriptions are omitted.

### Cleaning System 500

### <Configuration>

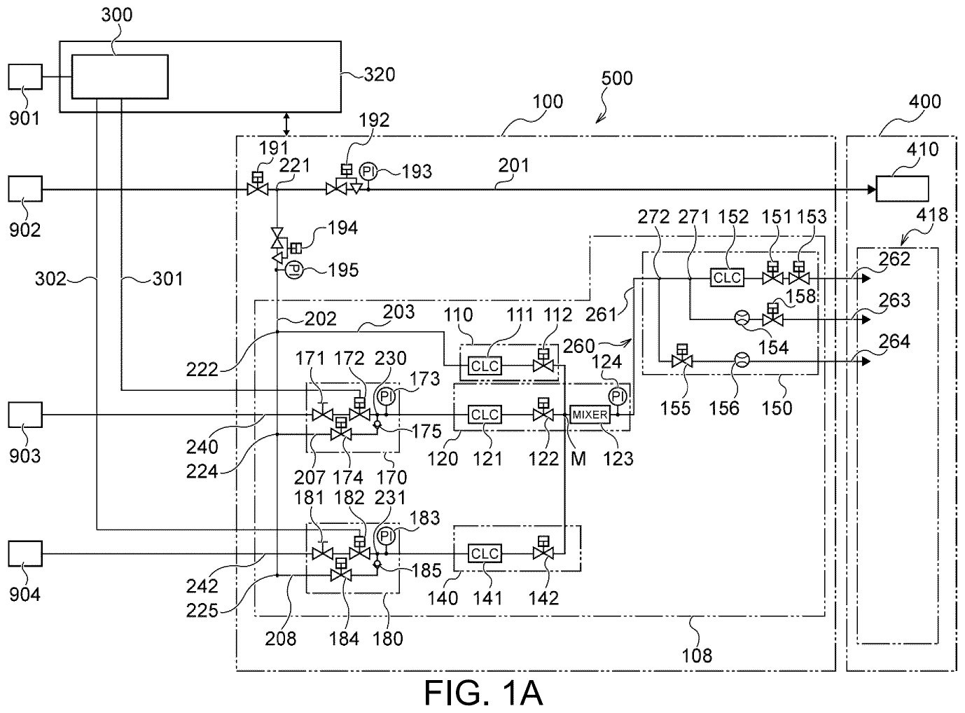

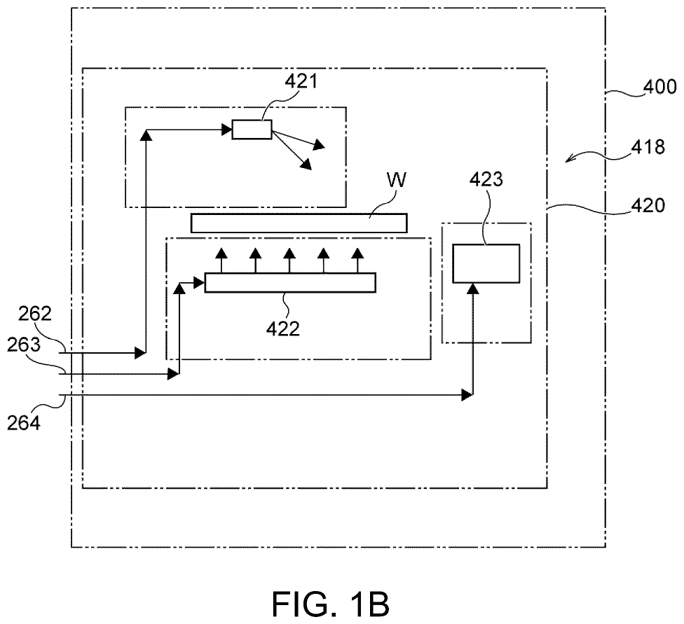

FIG. 1A is a fluid circuit diagram of a cleaning system 500 according to an embodiment of the disclosure. FIG. 1B is a fluid circuit diagram illustrating the substrate cleaning device 400 of FIG. 1A in detail. Referring to FIG. 1A, the cleaning system 500 includes a chemical liquid supply device 100, a substrate cleaning device (an example of an external device) 400, and a control device 320. The chemical liquid supply device 100 is a device for supplying water and a supply liquid to the substrate cleaning device 400. The substrate cleaning device 400 is a device for cleaning the substrate W using the water and the supply liquid supplied from the chemical liquid supply device 100. The configuration of each of the chemical liquid supply device 100 and the substrate cleaning device 400 is described below.

As shown in FIG. 1A, the substrate cleaning device 400 includes a water washing portion 410 and a cleaning module 418. The water washing portion 410 is configured to clean the substrate W polished by the polishing device using water (DIW). The water washing portion 410 is configured, as an example, to ultrasonically clean the substrate W.

As shown in FIG. 1B, the cleaning module 418 includes a first nozzle 421, a second nozzle 422, a standby portion 423, and a cleaning tank 420. The first nozzle 421 is configured to supply the supply liquid supplied from the chemical liquid supply device 100 to a first surface of the substrate W. The second nozzle 422 is configured to supply the supply liquid supplied from the chemical liquid supply device 100 to a second surface of the substrate W. Thereby, the substrate cleaning device 400 may simultaneously clean both surfaces of the substrate W with the supply liquid. It is noted that, as an example, the first surface of the substrate W is a pattern surface on which wiring is formed, and the second surface is a back surface of the first surface. Further, when cleaning the substrate W, the substrate W may be placed such that the first surface faces an arbitrary direction such as a vertical direction or a horizontal direction according to specifications.

Further, the standby portion 423 is configured to supply the supply liquid to the substrate W on standby before being cleaned by the first nozzle 421 and the second nozzle 422. Thereby, oxidation of the substrate W on standby is prevented. It is noted that, the standby portion 423 may have a nozzle for supplying the supply liquid to the substrate W or the sponge for wafer cleaning. Further, the cleaning tank 420 is configured to house the first nozzle 421, the second nozzle 422, and the standby portion 423.

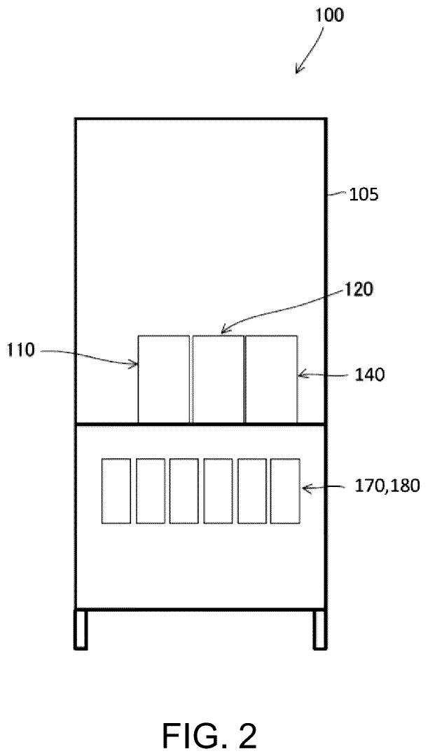

Next, reference is made to FIG. 2. As shown in FIG. 2, the chemical liquid supply device 100, as an example, includes a frame 105, a dilution water CLC box 110, a first chemical liquid CLC box 120, a second chemical liquid CLC box 140, and multiple utility boxes 170 and 180. The dilution water CLC box 110, the first chemical liquid CLC box 120, the second chemical liquid CLC box 140, and the multiple utility boxes 170 and 180 are housed in the frame 105.

Referring again to FIG. 1A, the chemical liquid supply device 100 includes a water pipe 201, a valve 191, a regulator 192, and a pressure gauge 193. The water pipe 201 connects a water supply source 902 and the water washing portion 410. Further, the water supply source 902, as an example, has a function of supplying water such as DIW. Thereby, the chemical liquid supply device 100 may supply water to the water washing portion 410. Further, the valve 191 is provided on the water pipe 201 upstream of a connection port 221. The valve 191 is controlled by the control device 320 and controls a flow rate of water flowing through the water pipe 201. The regulator 192 has a function of adjusting a supply pressure of water supplied to the water washing portion 410. The pressure gauge 193 has a function of measuring a pressure of water passing through the inside of the water pipe 201.

Further, the chemical liquid supply device 100, as an example, includes a supply module 108. The supply module 108 includes a junction point M, a first chemical liquid pipe 240, and a second chemical liquid pipe 242. The first chemical liquid pipe 240 connects a first chemical liquid supply source 903 and the junction point M. Thereby, the first chemical liquid supply source 903 and the junction point M are in fluid communication. Further, the first chemical liquid supply source 903, as an example, has a function of supplying a first chemical liquid. Thereby, the first chemical liquid is supplied from the first chemical liquid supply source 903 to the junction point M. On the other hand, the second chemical liquid pipe 242 connects a second chemical liquid supply source 904 and the junction point M. Thereby, the second chemical liquid supply source 904 and the junction point M are in fluid communication. Further, the second chemical liquid supply source 904, as an example, has a function of supplying a second chemical liquid. Thereby, the second chemical liquid is supplied from the second chemical liquid supply source 904 to the junction point M.

Further, the supply module 108 includes dilution water pipes 202 and 203. The dilution water pipe 202 extends from a connection port 221 provided on the water pipe 201 to a connection port 225. The dilution water pipe 203 extends from a connection port 222 provided on the dilution water pipe 202 to the junction point M. Thereby, the water supply source 902 and the junction point M are in fluid communication. As a result, water is supplied from the water supply source 902 to the junction point M.

Further, the supply module 108 includes a flow control device (an example of a dilution water control device, CLC: closed loop controller) 111 and a valve 112 (an example of a first valve). The valve 112 is attached to the dilution water pipe 203. The valve 112 is controlled by the control device 320 and is opened and closed. Further, the flow control device 111 is attached to the dilution water pipe 203. Then, the flow control device 111 is configured to perform feedback control so that a flow rate of water flowing through the dilution water pipe 203 becomes a set flow rate, based on the flow rate of water within the dilution water pipe 203. In other words, the flow control device 111 is configured to perform feedback control so that a flow rate of water supplied from the water supply source 902 to the junction point M becomes a set flow rate.

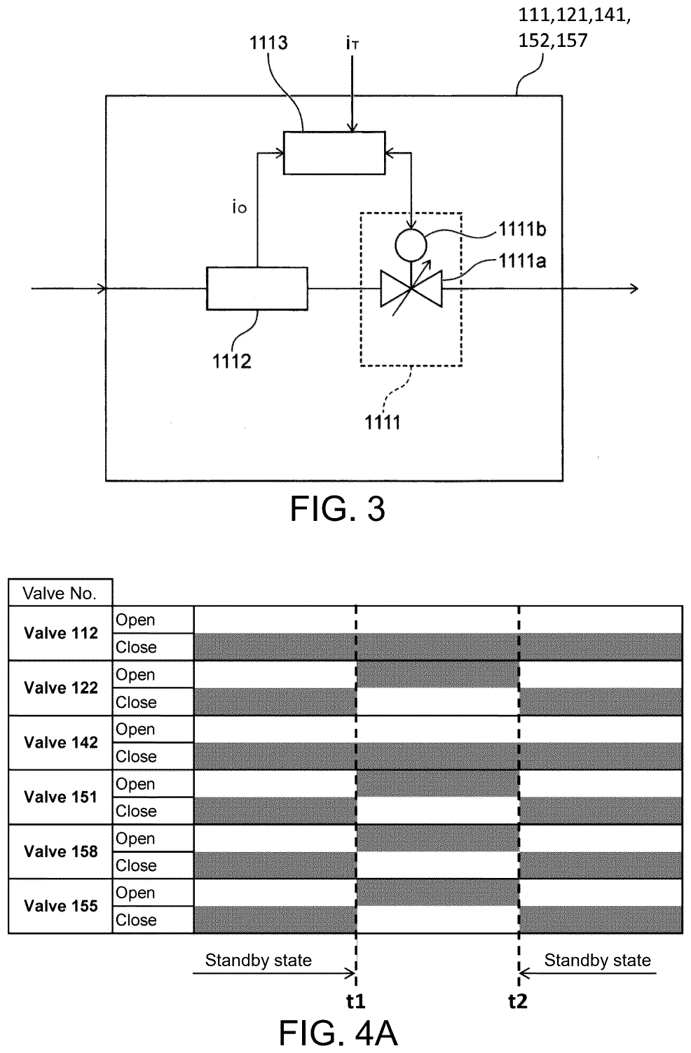

More specifically, the flow control device 111 has the configuration shown as an example in FIG. 3. FIG. 3 is a fluid circuit diagram illustrating the configuration of the flow control device 111 shown in FIG. 1A. The flow control device 111 includes a flow meter 1112, a flow control valve 1111, and a control portion 1113. The flow meter 1112 is, as an example, a differential pressure flow meter (orifice flow meter). It is noted that, in another embodiment according to the disclosure, the flow meter 1112 may be another flow meter such as an ultrasonic flow meter. The flow control valve 1111 is, as an example, a motor valve, and the valve opening degree of the valve main body 1111a is controlled by the power of a drive source 1111b including a motor. It is noted that, in another embodiment according to the disclosure, the flow control valve 1111 may be any valve whose opening degree may be adjusted, such as another type of variable flow valve (for example, a solenoid valve driven by a solenoid or the like). The control portion 1113 is configured to receive the flow rate set value iT of the fluid from the control device 320 (see FIG. 1A) and receive the flow rate detected value io of the fluid from the flow meter 1112, and to perform feedback control of the flow control valve 1111 so that the flow rate detected value io matches the flow rate set value iT. It is noted that, other flow control devices described later have, as an example, the same configuration as the flow control device 111 described here.

Referring again to FIG. 1A, the supply module 108 includes a flow control device (an example of a first chemical liquid control device) 121 and a valve (an example of a second valve) 122 (see FIG. 1A). The valve 122 is attached to the first chemical liquid pipe 240. The valve 122 is controlled by the control device 320 and is opened and closed. Further, the flow control device 121 is attached to the first chemical liquid pipe 240. Then, the flow control device 121 is configured to perform feedback control so that a flow rate of the first chemical liquid flowing through the first chemical liquid pipe 240 becomes a set flow rate, based on the flow rate of the first chemical liquid within the first chemical liquid pipe 240. In other words, the flow control device 121 is configured to perform feedback control so that a flow rate of the first chemical liquid supplied from the first chemical liquid supply source 903 to the junction point M becomes a set flow rate.

Further, the supply module 108 includes a flow control device (an example of a second chemical liquid control device) 141 and a valve (an example of a third valve) 142 (see FIG. 1A). The valve 142 is attached to the second chemical liquid pipe 242. The valve 142 is controlled by the control device 320 and is opened and closed. Further, the flow control device 141 is attached to the second chemical liquid pipe 242. Then, the flow control device 141 is configured to perform feedback control so that a flow rate of the second chemical liquid flowing through the second chemical liquid pipe 242 becomes a set flow rate, based on the flow rate of the second chemical liquid within the second chemical liquid pipe 242. In other words, the flow control device 141 is configured to perform feedback control so that a flow rate of the second chemical liquid supplied from the second chemical liquid supply source 904 to the junction point M becomes a set flow rate.

As described above, the supply module 108 is configured such that the first chemical liquid, the second chemical liquid, and water are supplied to the junction point M. The supply module 108 has a function to create a supply liquid as needed at the junction point M from the first chemical liquid, the second chemical liquid, and water supplied to the junction point M. It is noted that the supply liquid includes the first chemical liquid, the second chemical liquid, a first cleaning chemical liquid in which the first chemical liquid and water are mixed, a second cleaning chemical liquid in which the second chemical liquid and water are mixed, and a third cleaning chemical liquid in which the first chemical liquid, the second chemical liquid, and water are mixed. Further, the supply module 108 includes, as an example, a mixer 123. The mixer 123 is, as an example, an inline mixer, and is attached to an upstream pipe 261 of the cleaning chemical liquid supply pipe 260 downstream of the junction point M. Then, the mixer 123 has a function to mix the supply liquid created at the junction point M so that the supply liquid becomes uniform.

Further, the supply module 108 includes a manual valve 171 and a valve (an example of the fourth valve) 172. The manual valve 171 and the valve 172 are provided on the first chemical liquid pipe 240 and are housed in the utility box 170. The valve 172 is controlled by an air control device 300 described later and is opened and closed.

Further, the supply module 108 include a flushing water pipe 207, a valve (an example of the fifth valve) 174, and a check valve 175. The flushing water pipe 207 connects a connection port 224 provided at the dilution water pipe 202 and a connection port 230 provided at the first chemical liquid pipe 240. Then, the connection port 230 is located on the first chemical liquid pipe 240, between the flow control device 121 and the valve 172. Further, the valve 174 and the check valve 175 are provided on the flushing water pipe 207, and are housed in the utility box 170. The valve 174 is configured to be controlled by the control device 320 to open and close. The check valve 175 is configured to block the flow from the connection port 230 to the connection port 224. According to the valve 174 being opened, the flushing water flows from the connection port 230 into the first chemical liquid pipe 240. Thereby, the chemical liquid supply device 100 may replace the first chemical liquid inside the first chemical liquid pipe 240 with water, and flush (perform pipe cleaning on) the inside of the first chemical liquid pipe 240.

Further, the supply module 108 include a manual valve 181 and a valve (an example of the sixth valve) 182. The manual valve 181 and the valve 182 are provided on the second chemical liquid pipe 242, and are housed in the utility box 180. The valve 182 is controlled by an air control device 300 described later and is opened and closed.

Further, the supply module 108 include a flushing water pipe 208, a valve 184 (an example of the seventh valve) and a check valve 185. The flushing water pipe 208 connects a connection port 225 provided at the dilution water pipe 202 and a connection port 231 provided at the second chemical liquid pipe 242. Then, the connection port 231 is located on the second chemical liquid pipe 242, between the flow control device 141 and the valve 182. Further, the valve 184 and the check valve 185 are provided on the flushing water pipe 208, and are housed in the utility box 180. The valve 184 is configured to be controlled by the control device 320 to open and close. The check valve 185 is configured to block the flow from the connection port 231 to the connection port 225. According to the valve 184 being opened, the flushing water flows from the connection port 231 into the second chemical liquid pipe 242. Thereby, the chemical liquid supply device 100 may replace the second chemical liquid inside the second chemical liquid pipe 242 with water, and flush (perform pipe cleaning on) the inside of the second chemical liquid pipe 242.

Further, the supply module 108 includes the cleaning chemical liquid supply pipe 260. The cleaning chemical liquid supply pipe 260 is located downstream of the junction point M, and may supply the supply liquid to the substrate cleaning device 400. More specifically, the cleaning chemical liquid supply pipe 260 have the upstream pipe 261, a first pipe 262, a second pipe 263, and a third pipe 264. The upstream pipe 261 constitutes a flow path from the junction point M until the branch point 271. The first pipe 262 constitutes a flow path from the branch point 271 until the first nozzle 421 (see FIG. 1B). The second pipe 263 constitutes a flow path from the branch point 271 until the second nozzle 422 (see FIG. 1B). The third pipe 264 constitutes a flow path from a connection port 272 on the upstream pipe 261 until the standby portion 423 (see FIG. 1B). In other words, the cleaning chemical liquid supply pipe 260 is configured to connect the junction point M and the standby portion 423 via the third pipe 264. Thereby, the supply liquid may flow from the junction point M to the first nozzle 421, the second nozzle 422, and the standby portion 423. That is, the chemical liquid supply device 100 may supply the supply liquid to the first nozzle 421, the second nozzle 422, and the standby portion 423.

Further, the supply module 108 include a flow control device (an example of the first supply amount control device) 152. The flow control device 152 is attached to the first pipe 262. Then, the flow control device 152 is configured to perform feedback control so that a flow rate of the supply liquid flowing through the first pipe 262 becomes a set flow rate, based on the flow rate of the supply liquid inside the first pipe 262. Thereby, the chemical liquid supply device 100 may supply the supply liquid to the first nozzle 421 at the set flow rate.

Further, the supply module 108 include the valves 151, 158, and 155. The valve 151 is provided on the first pipe 262 between the flow control device 152 and the valve 153. The valve 158 is provided on the second pipe 263 downstream of the flow meter 154. The valve 155 is provided in the third pipe 264. The valves 151, 158, and 155 are configured to be controlled by the control device 320 to be opened and closed. More specifically, the valves 151, 158, and 155 are, as an example, on/off valves. It is noted that, in the disclosure, an on/off valve means a valve that may only adopt a two-stage configuration: a configuration in which the valve opening degree is fully open, and a configuration in which the valve opening degree is fully closed. It is noted that, in another embodiment according to the disclosure, the valves 151, 158, and 155 may be continuous control valves capable of continuously changing the valve opening degree, instead of on/off valves.

Further, the supply module 108 include the valve 153. The valve 153 is provided on the first pipe 262 downstream of the flow control device 152. The valve 153 is, as an example, a suck-back valve. Then, the valve 153 is configured to perform a suck-back operation to suck back the liquid in the first pipe 262 downstream of the valve 153, in response to the valve 151 being closed.

The supply module 108 also includes flow meters 154 and 156. The flow meter 154 is provided on the second pipe 263 and measures the flow rate of the supply liquid flowing through the second pipe 263. The flow meter 156 is provided on the third pipe 264 and measures the flow rate of the supply liquid flowing through the third pipe 264.

Further, the chemical liquid supply device 100 include a first cleaning chemical liquid supply box 150. The first cleaning chemical liquid supply box 150 houses the flow control device 152, the valves 153, 155, 158, and 151, and the flow meters 154 and 156.

Further, the chemical liquid supply device 100 includes an IN side pressure gauge 173, an IN side pressure gauge 183, an IN side pressure gauge 195, and an OUT side pressure gauge 124. The IN side pressure gauge 173 is provided between the first chemical liquid supply source 903 and the flow control device 121. Thereby, the IN side pressure gauge 173 may measure the pressure upstream of the flow control device 121. The IN side pressure gauge 183 is provided between the second chemical liquid supply source 904 and the flow control device 141. Thereby, the IN side pressure gauge 183 may measure the pressure upstream of the flow control device 141. The IN side pressure gauge 195 is provided at a position between the water supply source 902 and the flow control device 111. Thereby, the IN side pressure gauge 195 may measure the pressure upstream of the flow control device 111. Further, the OUT side pressure gauge 124 is provided at a position between the flow control device 111 and the flow control device 152, at a position between the flow control device 121 and the flow control device 152, and at a position between the flow control device 141 and the flow control device 152. Thereby, the OUT side pressure gauge 124 may measure the pressure inside the upstream pipe 261 of the cleaning chemical liquid supply pipe 260.

Further, in the chemical liquid supply device 100, the first chemical liquid CLC box 120, as an example, houses the flow control device 121, the valve 122, the mixer 123, and the OUT side pressure gauge 124. The second chemical liquid CLC box 140, as an example, houses the flow control device 141 and the valve 142. The dilution water CLC box 110, as an example, houses the flow control device 111 and the valve 112.

Further, the chemical liquid supply device 100 include a regulator 194. The regulator 194 is provided on the dilution water pipe 202 downstream of the connection port 221 and upstream of the IN side pressure gauge 195. The regulator 194 have a function to adjust the supply pressure of water supplied to the flow control device 111.

Further, the chemical liquid supply device 100 includes the air control device 300 and air pipes 301 and 302. The air control device 300 is included in the control device 320, and is controlled by the control device 320. The air control device 300 is connected to an air supply source 901. The air supply source 901 has a function to supply gas to the air control device 300. The air pipe 301 connects the air control device 300 and the valve 172. The air pipe 302 connects the air control device 300 and the valve 182. The air control device 300 controls the valves 172 and 182 by sending air to the valves 172 and 182 via the air pipes 301 and 302.

Further, in FIG. 1A, the chemical liquid supply device 100 includes only one supply module 108. However, the chemical liquid supply device 100 is not limited to such a configuration. In another embodiment according to the disclosure, the chemical liquid supply device 100 may optionally include two or more supply modules 108. Similarly, the substrate cleaning device 400 may optionally include two or more cleaning modules 418.

### <Operation>

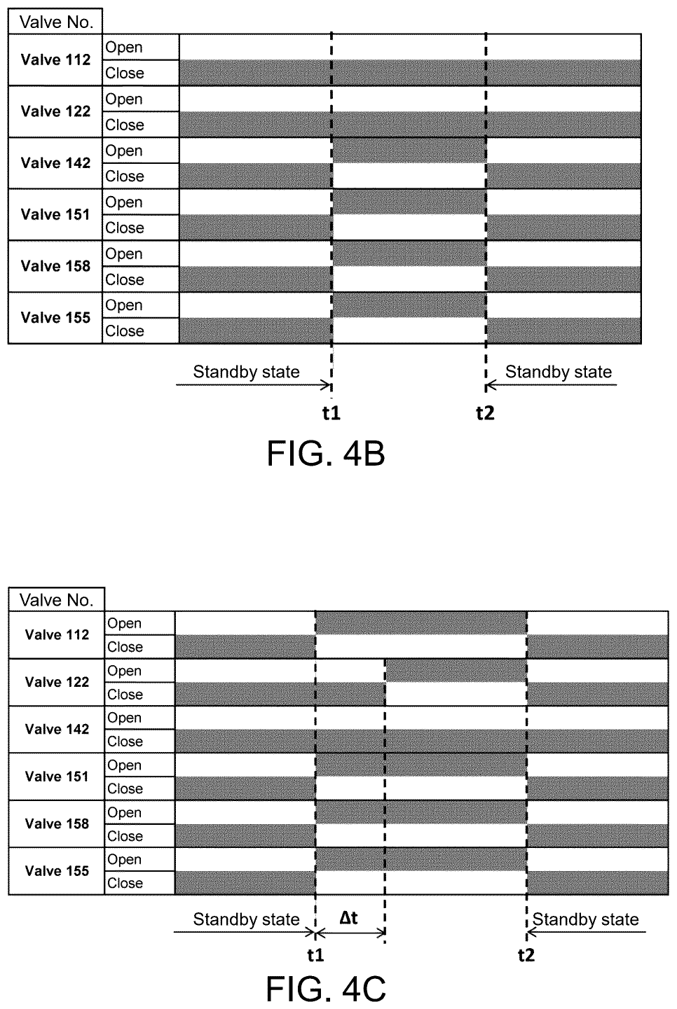

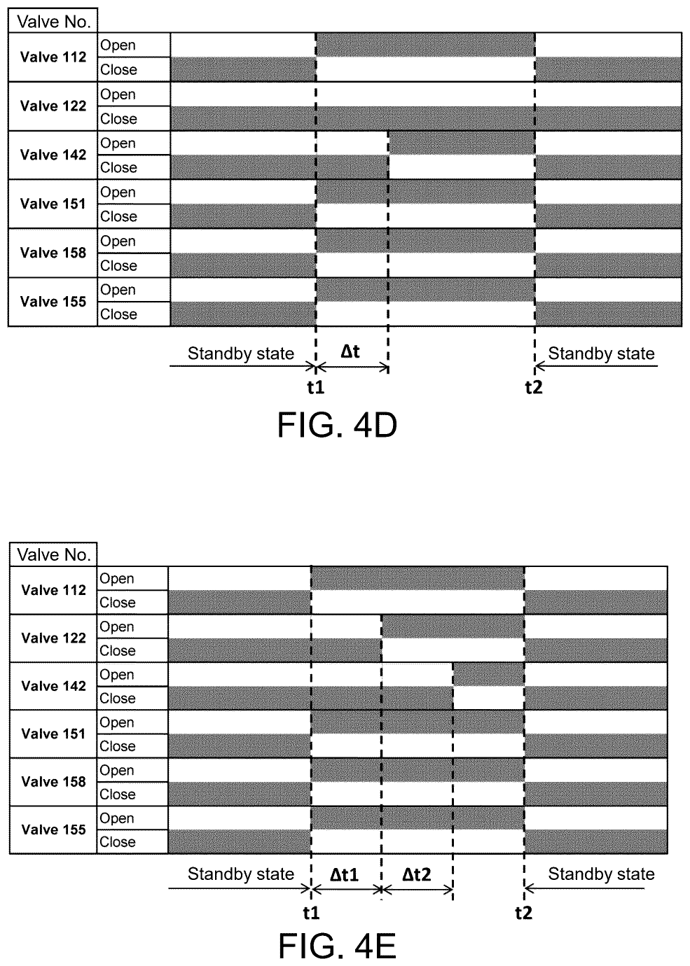

Next, the operation of the cleaning system 500 will be described with reference to FIG. 1A, FIG. 1B, and FIG. 4A to FIG. 4E. The control device 320 is configured to be operable in at least a first mode, a second mode, a third mode, a fourth mode, and a fifth mode. Hereinafter, the operation of each mode will be described in this order.

### (First Mode)

FIG. 4A is a time chart illustrating the opening/closing timing of each valve during operation of the control device 320 in the first mode. As shown in FIG. 4A, before the control device 320 starts operation in the first mode, the cleaning system 500 is in the standby state. In the standby state, the valves 112, 122, 142, 151, 158, 155, 174, and 184 are closed, and the valves 172 and 182 are opened. It is noted that the standby state in the description provided later also means the same state.

At time t1, in response to the control device 320 starting operation in the first mode, the control device 320 opens the valve 122, the valve 151, the valve 158, and the valve 155. Thereby, the first chemical liquid passing through the first chemical liquid pipe 240 is supplied as the supply liquid, passing through the junction point M, to the first nozzle 421, the second nozzle 422, and the standby portion 423 (see FIG. 1A and FIG. 1B). In other words, the chemical liquid supply device 100 may supply only the first chemical liquid as the supply liquid to the substrate cleaning device 400 in the first mode. Thereafter, in response to the control device 320 ending the operation in the first mode at time t2, the control device 320 closes the valve 122, the valve 151, and the valve 158, and the cleaning system 500 returns to the standby state.

It is noted that, in the first mode shown in FIG. 4A, the control device 320 opens all of the valve 151, the valve 158, and the valve 155. However, in another embodiment according to the disclosure, the control device 320 does not need to perform such control. The control device 320 may optionally open any one of the valve 151, the valve 158, and the valve 155.

### (Second Mode)

FIG. 4B is a time chart illustrating the opening/closing timing of each valve during operation of the control device 320 in the second mode. As shown in FIG. 4B, before the control device 320 starts operation in the second mode, the cleaning system 500 is in the standby state.

At time t1, in response to the control device 320 starting operation in the second mode, the control device 320 opens the valve 142, the valve 151, the valve 158, and the valve 155. Thereby, the second chemical liquid passing through the second chemical liquid pipe 242 is supplied as the supply liquid, passing through the junction point M, to the first nozzle 421, the second nozzle 422, and the standby portion 423 (see FIG. 1A and FIG. 1B). In other words, the chemical liquid supply device 100 may supply only the second chemical liquid as the supply liquid to the substrate cleaning device 400 in the second mode. Thereafter, in response to the control device 320 ending the operation in the second mode at time t2, the control device 320 closes the valve 142, the valve 151, and the valve 158, and the cleaning system 500 returns to the standby state.

It is noted that, in the second mode shown in FIG. 4B, the control device 320 opens all of the valve 151, the valve 158, and the valve 155. However, in another embodiment according to the disclosure, the control device 320 does not need to perform such control. The control device 320 may optionally open any one of the valve 151, the valve 158, and the valve 155.

### (Third Mode)

FIG. 4C is a time chart illustrating the opening/closing timing of each valve during operation of the control device 320 in the third mode. As shown in FIG. 4C, before the control device 320 starts operation in the third mode, the cleaning system 500 is in the standby state.

At time t1, in response to the control device 320 starting operation in the third mode, the control device 320 opens the valve 112, the valve 151, the valve 158, and the valve 155. Then, after delay time Δt from time t1, the control device 320 opens the valve 122. Thereby, the first chemical liquid passing through the first chemical liquid pipe 240 and the water passing through the dilution water pipe 203 are supplied to the junction point M (see FIG. 1A). Then, at the junction point M, the first chemical liquid and the water are mixed, and the first cleaning chemical liquid is created. It is noted that the delay time Δt may be 0.1, 0.2, 0.3, 0.4, or 0.5 seconds. Thereafter, the first cleaning chemical liquid is supplied as the supply liquid to the first nozzle 421, the second nozzle 422, and the standby portion 423 (see FIG. 1A and FIG. 1B). In other words, the chemical liquid supply device 100 may supply the first cleaning chemical liquid as the supply liquid to the substrate cleaning device 400 in the third mode. Thereafter, in response to the control device 320 ending the operation in the third mode at time t2, the control device 320 closes the valve 112, the valve 122, the valve 151, the valve 158, and the valve 155, and the cleaning system 500 returns to the standby state.

It is noted that, in the third mode shown in FIG. 4C, the control device 320 opens all of the valve 151, the valve 158, and the valve 155. However, in another embodiment according to the disclosure, the control device 320 does not need to perform such control. The control device 320 may optionally open any one of the valve 151, the valve 158, and the valve 155.

Further, in the third mode, the control device 320 opens the valve 122 after opening the valve 112. Thereby, water that has passed through the dilution water pipe 203 is first supplied to the first nozzle 421, the second nozzle 422, and the standby portion 423. In other words, the control device 320 controls the valve 112 and the valve 122 such that water that has passed through the dilution water pipe 203 is first supplied to the substrate cleaning device 400. Thereby, the supply of the first chemical liquid, which is not thinned by water, to the substrate W is prevented. That is, the chemical liquid supply device 100 may prevent the first chemical liquid, which is not thinned by water, from being supplied to the substrate W and causing damage to the substrate W.

### (Fourth Mode)

FIG. 4D is a time chart illustrating the opening/closing timing of each valve during operation of the control device 320 in the fourth mode. As shown in FIG. 4D, before the control device 320 starts operation in the fourth mode, the cleaning system 500 is in the standby state.

At time t1, in response to the control device 320 starting operation in the fourth mode, the control device 320 opens the valve 112, the valve 151, the valve 158, and the valve 155. Then, after delay time Δt from time t1, the control device 320 opens the valve 142. Thereby, the second chemical liquid passing through the second chemical liquid pipe 242 and water passing through the dilution water pipe 203 are supplied to the junction point M (see FIG. 1A). Then, at the junction point M, the second chemical liquid and water are mixed, and a second cleaning chemical liquid is created. It is noted that the delay time Δt may be 0.1, 0.2, 0.3, 0.4, or 0.5 seconds. Thereafter, the second cleaning chemical liquid, as the supply liquid, is supplied to the first nozzle 421, the second nozzle 422, and the standby portion 423 (see FIG. 1A and FIG. 1B). In other words, the chemical liquid supply device 100 may supply the second cleaning chemical liquid as the supply liquid to the substrate cleaning device 400 in the fourth mode. Thereafter, in response to the control device 320 ending the operation in the fourth mode at time t2, the control device 320 closes the valve 112, the valve 142, the valve 151, the valve 158, and the valve 155, and the cleaning system 500 returns to the standby state.

It is noted that, in the fourth mode shown in FIG. 4D, the control device 320 opens all of the valve 151, the valve 158, and the valve 155. However, in another embodiment according to the disclosure, the control device 320 does not need to perform such control. The control device 320 may optionally open any one of the valve 151, the valve 158, and the valve 155.

Further, in the fourth mode, the control device 320 opens the valve 142 after opening the valve 112. Thereby, water that has passed through the dilution water pipe 203 is first supplied to the first nozzle 421, the second nozzle 422, and the standby portion 423. In other words, the control device 320 controls the valve 112 and the valve 142 such that water that has passed through the dilution water pipe 203 is first supplied to the substrate cleaning device 400. That is, the chemical liquid supply device 100 may prevent the second chemical liquid, which is not thinned by water, from being supplied to the substrate W and causing damage to the substrate W.

### (Fifth Mode)

FIG. 4E is a time chart illustrating the opening/closing timing of each valve during operation of the control device 320 in the fifth mode. As shown in FIG. 4E, before the control device 320 starts operation in the fifth mode, the cleaning system 500 is in the standby state.

At time t1, in response to the control device 320 starting operation in the fifth mode, the control device 320 opens the valve 112, the valve 151, the valve 158, and the valve 155. Then, after delay time Δt1 from time t1, the control device 320 opens the valve 122. Next, after delay time Δt2 from the opening of the valve 122, the control device 320 opens the valve 122. Thereby, the first chemical liquid passing through the first chemical liquid pipe 240, the second chemical liquid passing through the second chemical liquid pipe 242, and water passing through the dilution water pipe 203 are supplied to the junction point M (see FIG. 1A). Then, at the junction point M, the first chemical liquid, the second chemical liquid, and water are mixed, and a third cleaning chemical liquid is created. It is noted that the delay time Δt1 and the delay time Δt2 may be 0.1, 0.2, 0.3, 0.4, or 0.5 seconds. Thereafter, the third cleaning chemical liquid is supplied as the supply liquid to the first nozzle 421, the second nozzle 422, and the standby portion 423 (see FIG. 1A and FIG. 1B). In other words, the chemical liquid supply device 100 may supply the third cleaning chemical liquid as the supply liquid to the substrate cleaning device 400 in the fifth mode. Thereafter, in response to the control device 320 ending the operation in the fifth mode at time t2, the control device 320 closes the valve 112, the valve 122, the valve 142, the valve 151, the valve 158, and the valve 155, and the cleaning system 500 returns to the standby state.

It is noted that, in the fifth mode shown in FIG. 4E, the control device 320 opens all of the valve 151, the valve 158, and the valve 155. However, in another embodiment according to the disclosure, the control device 320 does not need to perform such control. The control device 320 may optionally open any one of the valve 151, the valve 158, and the valve 155.

Further, in the fifth mode, the control device 320 opens the valve 122 and the valve 142 after opening the valve 112. Thereby, water that has passed through the dilution water pipe 203 is first supplied to the first nozzle 421, the second nozzle 422, and the standby portion 423. In other words, the control device 320 controls the valve 112, the valve 122, and the valve 142 such that water that has passed through the dilution water pipe 203 is first supplied to the substrate cleaning device 400. Thereby, the chemical liquid supply device 100 may prevent at least one of the first chemical liquid and the second chemical liquid, which is not thinned by water, from being supplied to the substrate W and causing damage to the substrate W.

### <Flushing Operation>

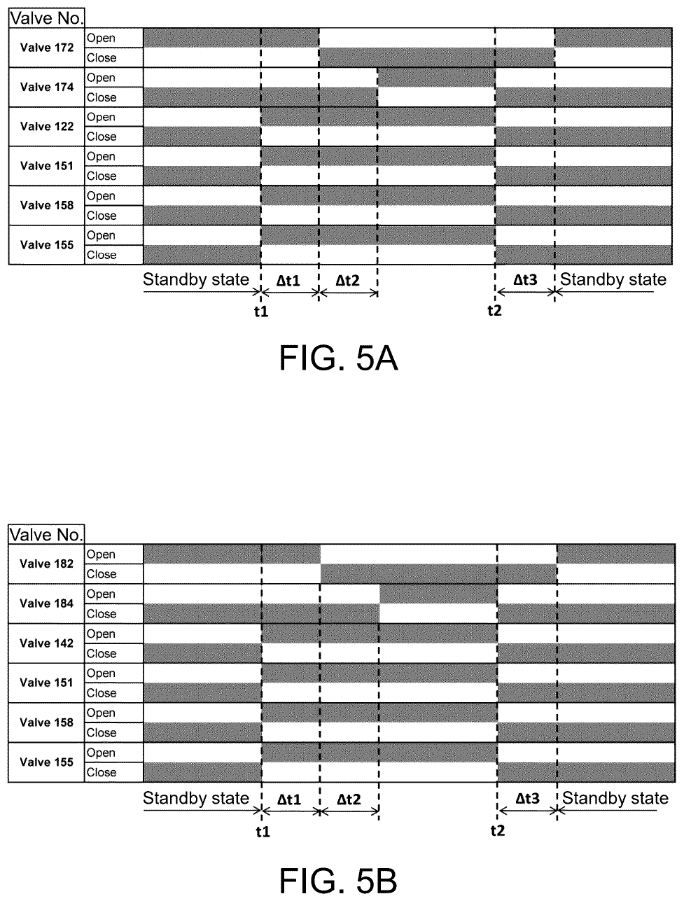

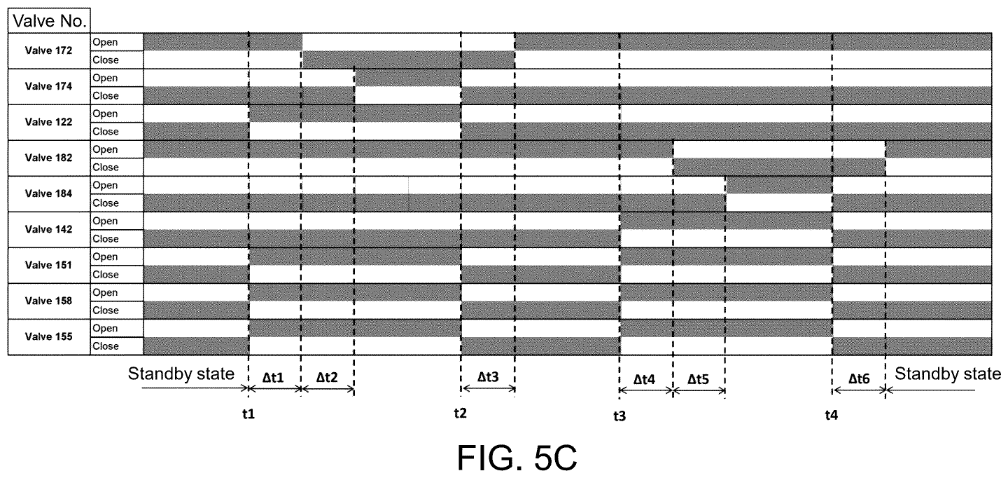

Furthermore, the control device 320 is configured to operate in at least a first flushing mode, a second flushing mode, and a third flushing mode. With reference to FIG. 1A, FIG. 1B, and FIG. 5A to FIG. 5C, the three flushing modes of the control device 320 will be described.

### (First Flushing Mode)

FIG. 5A is a time chart illustrating the opening/closing timing of each valve during operation of the control device 320 in the first flushing mode. The first flushing mode is a mode for cleaning the first chemical liquid pipe 240 and its downstream by flowing water into the first chemical liquid pipe 240. As shown in FIG. 5A, before the control device 320 operates in the first flushing mode, the cleaning system 500 is in a standby state.

First, in the first flushing mode, cleaning of the first chemical liquid pipe 240 starts at time t1. More specifically, the control device 320 opens the valve 122, the valve 151, the valve 158, and the valve 155 at time t3. Next, after delay time Δt1 from time t1, the control device 320 closes the valve 172. Next, after a delay time (an example of a first delay time) Δt2 from the closing of the valve 172, the control device 320 opens the valve 174. As a result, the liquid inside the first chemical liquid pipe 240 and the cleaning chemical liquid supply pipe 260 is replaced with water, and the inside of the first chemical liquid pipe 240 and the inside of the cleaning chemical liquid supply pipe 260 are cleaned (see FIG. 1A). It is noted that the delay time Δt1 and the delay time Δt2 may be 0.1, 0.2, 0.3, 0.4, or 0.5 seconds.

Next, in the first flushing mode, end processing of the cleaning of the first chemical liquid pipe 240 starts at time t2. More specifically, the control device 320 closes the valve 174, the valve 122, the valve 151, the valve 158, and the valve 155 at time t2. Next, after a delay time (an example of a second delay time) Δt3 from time t2, the control device 320 opens the valve 172. Thereby, the water flowing through the first chemical liquid pipe 240 and the cleaning chemical liquid supply pipe 260 stops, and the cleaning system 500 returns to the standby state. It is noted that the delay time Δt3 may be 0.1, 0.2, 0.3, 0.4, or 0.5 seconds.

As described above, in the first flushing mode, the valve 174 is opened after delay time Δt2 from the closing of the valve 172. Thereby, the occurrence of errors that may occur in the flow control device 121 is suppressed. Hereinafter, errors that may occur in the flow control device 121 and the reason why these errors are suppressed will be described.

In the case of miniaturization of the chemical liquid supply device 100, the distance between each component becomes shorter. Consequently, the distance between the valve 172 and the flow control device 121 becomes shorter, and the volume inside the pipe in this section becomes smaller (see FIG. 1A). Thus, when the valve 172 is closed and the valve 174 is opened at the same time, the impact due to the closing of the valve 172 is transmitted to the small volume of the pipe between the valve 172 and the flow control device 121 formed by the closing of the valve 172, and water flows in from the valve 174. As a result, the pressure inside the pipe in this section may rapidly increase (spike). That is, the detected value of the flow meter 1112 of the flow control device 121 adjacent to this section overshoots, and there is a risk that a pressure upper limit error occurs. In an integrated module, for the small volume inside the pipe, there may be a risk that a rapid pressure increase occurs due to the inflow of liquid with a volume of several cc. From the above, the flow control device 121 has a risk of generating a pressure upper limit error.

In contrast, in the chemical liquid supply device 100, the valve 174 is opened after delay time Δt2 from the closing of the valve 172. Thus, because a predetermined delay time Δt2 is provided between the closing timing of the valve 172 and the opening timing of the valve 174, during the delay time Δt2, the pressure increase inside the pipe between the valve 172 and the flow control device 121, which is caused by the closing of the valve 172, escapes to the downstream side from the flow control valve 1211 of the flow control device 121. As a result, a rapid increase in the pressure inside the pipe in this section is suppressed. That is, the occurrence of the pressure upper limit error of the flow control device 121 is suppressed.

Further, by providing the delay time Δt2, the valve 174 opens after the valve 172 is reliably closed. Thus, the period during which the valve 172 and the valve 174 are simultaneously open is reliably eliminated, and water from the valve 174 is suppressed from flowing back to the upstream side of the valve 172.

Further, at the time of the end processing for cleaning the first chemical liquid pipe 240, in the case that the delay time Δt3 is not set, a similar error may occur. That is, even in the case that the valve 174 closes and the valve 172 opens, the pressure inside the pipe between the valve 172 and the flow control device 121 increases, and there is a possibility that a pressure upper limit error of the flow meter 1112 of the flow control device 121 occurs.

However, in the chemical liquid supply device 100, the delay time Δt3 is set. That is, the valve 172 is opened after the delay time Δt3 from the closing of the valve 174. Thus, in the chemical liquid supply device 100, even in the case of the end processing for cleaning the first chemical liquid pipe 240, the occurrence of the pressure upper limit error of the flow meter 1112 of the flow control device 121 is suppressed.

### (Second Flushing Mode)

FIG. 5B is a time chart illustrating the opening/closing timing of each valve during operation of the control device 320 in the second flushing mode. The second flushing mode is a mode for cleaning the second chemical liquid pipe 242 and its downstream side by flowing water into the second chemical liquid pipe 242. As shown in FIG. 5B, before the control device 320 operates in the second flushing mode, the cleaning system 500 is in a standby state.

First, in the second flushing mode, cleaning of the second chemical liquid pipe 242 is started at time t1. More specifically, the control device 320 opens the valve 142, the valve 151, the valve 158, and the valve 155 at time t3. Next, after delay time Δt1 from time t1, the control device 320 closes the valve 182. Next, after a delay time (an example of a third delay time) Δt2 from the closing of the valve 182, the control device 320 opens the valve 184. As a result, the liquid inside the second chemical liquid pipe 242 and the cleaning chemical liquid supply pipe 260 is replaced with water, and the inside of the second chemical liquid pipe 242 and the inside of the cleaning chemical liquid supply pipe 260 are cleaned (see FIG. 1A). It is noted that the delay time Δt1 and the delay time Δt2 may be 0.1, 0.2, 0.3, 0.4, or 0.5 seconds.

Next, in the second flushing mode, the end processing for cleaning of the second chemical liquid pipe 242 is started at time t2. More specifically, the control device 320 closes the valve 184, the valve 142, the valve 151, the valve 158, and the valve 155 at time t2. Next, after a delay time (an example of a fourth delay time) Δt3 from time t2, the control device 320 opens the valve 182. As a result, water flowing through the second chemical liquid pipe 242 and the cleaning chemical liquid supply pipe 260 stops, and the cleaning system 500 returns to the standby state. It is noted that the delay time Δt3 may be 0.1, 0.2, 0.3, 0.4, or 0.5 seconds.

As described above, in the second flushing mode, the valve 174 is opened after the delay time Δt2 from the closing of the valve 172. As a result, the occurrence of the pressure upper limit error that may occur in the flow control device 141 is suppressed. Furthermore, backflow of water from the valve 184 to the upstream side of the valve 182 is suppressed. The reason why the occurrence of these problems is suppressed is the same as in the case of the first flushing mode, and thus, its description is omitted.

Further, in the second flushing mode, the delay time Δt3 is set. Thus, in the chemical liquid supply device 100, also in the case of the end processing of the cleaning of the second chemical liquid pipe 242, the occurrence of the pressure upper limit error of the flow meter 1112 of the flow control device 141 is suppressed. The reason why the occurrence of this problem is suppressed is the same as in the case of the first flushing mode, and thus, its description is omitted.

### (Third Flushing Mode)

FIG. 5C is a time chart illustrating the opening/closing timing of each valve during operation of the control device 320 in the third flushing mode. The third flushing mode is a mode for cleaning the first chemical liquid pipe 240, the second chemical liquid pipe 242, and downstream of these pipes by flowing water to the first chemical liquid pipe 240 and the second chemical liquid pipe 242. As can be seen from FIG. 5C, the operation of the control device 320 in the third flushing mode is the same as the manner in which the control device 320 performs the operation of the control device 320 in the first flushing mode, and then the control device 320 performs the operation of the control device 320 in the second flushing mode. Hereinafter, the operation of the control device 320 in the third flushing mode will be described more specifically.

First, in the third flushing mode, cleaning of the first chemical liquid pipe 240 is started at time t1. More specifically, the control device 320 opens the valve 122, the valve 151, the valve 158, and the valve 155 at time t3. Next, after delay time Δt1 from time t1, the control device 320 closes the valve 172. Next, after delay time Δt2 from the closing of the valve 172, the control device 320 opens the valve 174. As a result, the liquid inside the first chemical liquid pipe 240 and the cleaning chemical liquid supply pipe 260 is replaced with water, and the inside of the first chemical liquid pipe 240 and the inside of the cleaning chemical liquid supply pipe 260 are cleaned (see FIG. 1A). It is noted that the delay time Δt1 and the delay time Δt2 may be 0.1, 0.2, 0.3, 0.4, or 0.5 seconds.

Next, in the third flushing mode, the end processing of the cleaning of the first chemical liquid pipe 240 is started at time t2. More specifically, the control device 320 closes the valve 174, the valve 122, the valve 151, the valve 158, and the valve 155 at time t2. Next, after delay time Δt3 from time t2, the control device 320 opens the valve 172. As a result, the water flowing through the first chemical liquid pipe 240 and the cleaning chemical liquid supply pipe 260 stops. It is noted that the delay time Δt3 may be 0.1, 0.2, 0.3, 0.4, or 0.5 seconds.

Next, in the third flushing mode, cleaning of the second chemical liquid pipe 242 is started at time t3. More specifically, the control device 320 opens the valve 142, the valve 151, the valve 158, and the valve 155 at time t3. Next, after delay time Δt4 from time t3, the control device 320 closes the valve 182. Next, after delay time Δt5 from the closing of the valve 182, the control device 320 opens the valve 184. As a result, the liquid inside the second chemical liquid pipe 242 and the cleaning chemical liquid supply pipe 260 is replaced with water, and the inside of the second chemical liquid pipe 242 and the inside of the cleaning chemical liquid supply pipe 260 are cleaned (see FIG. 1A). It is noted that the delay time Δt4 and the delay time Δt5 may be 0.1, 0.2, 0.3, 0.4, or 0.5 seconds.

Next, in the third flushing mode, the end processing of the cleaning of the second chemical liquid pipe 242 is started at time t4. More specifically, the control device 320 closes the valve 184, the valve 142, the valve 151, the valve 158, and the valve 155 at time t4. Next, after delay time Δt6 from time t4, the control device 320 opens the valve 182. As a result, water flowing through the second chemical liquid pipe 242 and the cleaning chemical liquid supply pipe 260 stops, and the cleaning system 500 returns to the standby state. It is noted that the delay time Δt6 may be 0.1, 0.2, 0.3, 0.4, or 0.5 seconds.

In the third flushing mode, the control device 320 operates in this manner. Thus, in the third flushing mode, the inside of the first chemical liquid pipe 240, the inside of the second chemical liquid pipe 242, and the inside of the cleaning chemical liquid supply pipe 260 are cleaned with water.

### Cleaning System 502

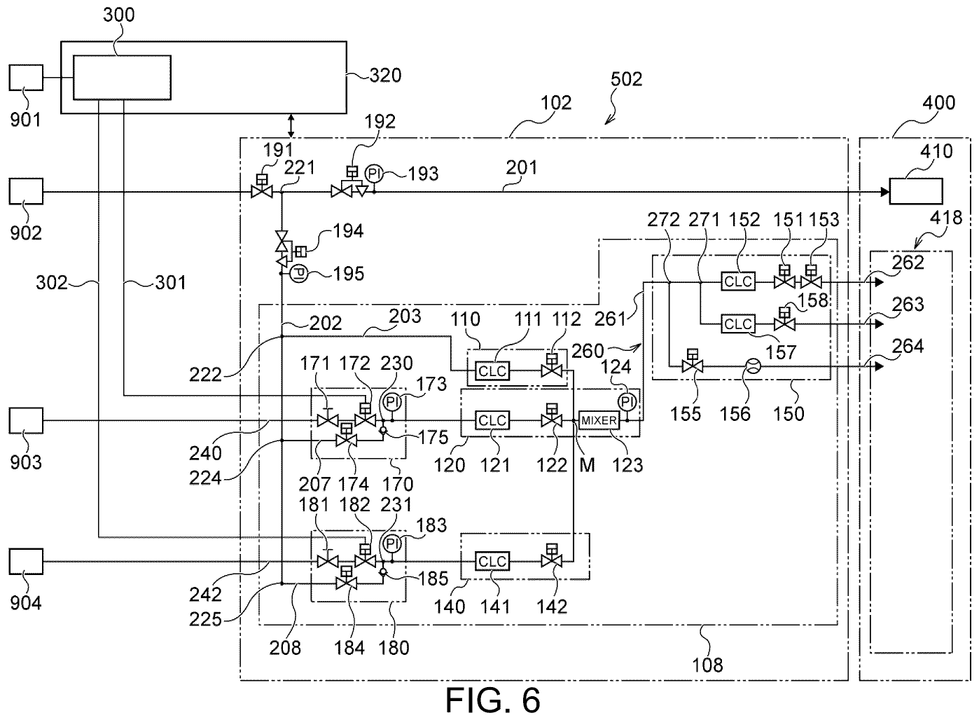

Next, reference is made to FIG. 6. FIG. 6 is a chemical fluid circuit diagram of a cleaning system 502 according to another embodiment different from the cleaning system 500. As shown in FIG. 6, the cleaning system 502 includes a chemical liquid supply device 102 and a substrate cleaning device 400. That is, the substrate cleaning device 400 included in the cleaning system 502 is identical to the substrate cleaning device 400 included in the cleaning system 500 described above. Thus, the description of the substrate cleaning device 400 is omitted. Further, the chemical liquid supply device 102 differs from the chemical liquid supply device 100 in points such as including a flow control device (second supply amount control device) 157 and not including the flow meter 154 that the chemical liquid supply device 100 has, etc. Hereinafter, regarding the chemical liquid supply device 102, parts different from the chemical liquid supply device 100 will be mainly described, and for common configurations, the same reference numerals are attached in the figures, and description therefor is omitted.

As described above, the chemical liquid supply device 102 includes a flow control device (an example of a second supply amount control device) 157. The flow control device 157 is attached to the second pipe 263. Then, the flow control device 157 is configured to perform feedback control so that a flow rate of the supply liquid flowing through the second pipe 263 becomes a set flow rate, based on the flow rate of the supply liquid inside the second pipe 263. As a result, the chemical liquid supply device 102 may supply the supply liquid to the second nozzle 422 (see FIG. 1B) at a set flow rate.

Further, the cleaning system 502 is operable in the same manner as the cleaning system 500. For this reason, a description of the operation of the cleaning system 502 is omitted.

### APPENDIX

Part or all of the above embodiments may be described as in the following appendix, but are not limited to the following.

### Appendix 1

The chemical liquid supply device according to Appendix 1 is a chemical liquid supply device for supplying a supply liquid to an external device, and includes: a junction point; a dilution water pipe for supplying water to the junction point; a first chemical liquid pipe for supplying a first chemical liquid to the junction point; a second chemical liquid pipe for supplying a second chemical liquid to the junction point; a first valve attached to the dilution water pipe; a second valve attached to the first chemical liquid pipe; a third valve attached to the second chemical liquid pipe; a cleaning chemical liquid supply pipe located downstream of the junction point, for supplying the supply liquid to the external device; and a control device operable in a first mode, a second mode, a third mode, a fourth mode, and a fifth mode. The control device controls the first valve, the second valve, and the third valve such that in the first mode, only the first chemical liquid is supplied to the external device as the supply liquid, in the second mode, only the second chemical liquid is supplied to the external device as the supply liquid, in the third mode, a first cleaning chemical liquid formed by mixing the first chemical liquid and the water is supplied to the external device as the supply liquid, in the fourth mode, a second cleaning chemical liquid formed by mixing the second chemical liquid and the water is supplied to the external device as the supply liquid, and in the fifth mode, a third cleaning chemical liquid formed by mixing the first chemical liquid, the second chemical liquid, and the water is supplied to the external device as the supply liquid.

The chemical liquid supply device according to Appendix 1 may supply the first chemical liquid, the second chemical liquid, the first cleaning chemical liquid, the second cleaning chemical liquid, and the third cleaning chemical liquid as the supply liquid to the external device. That is, this chemical liquid supply device may also supply liquids other than a cleaning liquid formed by diluting arbitrary two types of chemical liquids with pure water, to the external device.

### Appendix 2

The chemical liquid supply device according to Appendix 2 is the chemical liquid supply device according to Appendix 1, and includes: a dilution water control device attached to the dilution water pipe and configured to perform feedback control such that a flow rate of water supplied to the junction point becomes a set flow rate; a first chemical liquid control device attached to the first chemical liquid pipe and configured to perform feedback control such that a flow rate of the first chemical liquid supplied to the junction point becomes a set flow rate; and a second chemical liquid control device attached to the second chemical liquid pipe and configured to perform feedback control such that a flow rate of the second chemical liquid supplied to the junction point becomes a set flow rate.

### Appendix 3

The chemical liquid supply device according to Appendix 3 is the chemical liquid supply device according to Appendix 1 or 2, in which the cleaning chemical liquid supply pipe has an upstream pipe constituting a flow path from the junction point to a branch point, a first pipe constituting a flow path from the branch point to a first nozzle, and a second pipe constituting a flow path from the branch point to a second nozzle.

The chemical liquid supply device according to Appendix 3 may supply the supply liquid to the first nozzle and the second nozzle.

### Appendix 4

The chemical liquid supply device according to Appendix 4 is the chemical liquid supply device according to Appendix 3, and includes: a first supply amount control device attached to the first pipe and configured to perform feedback control such that a flow rate of a liquid supplied to the first nozzle becomes a set flow rate, and a second supply amount control device attached to the second pipe and configured to perform feedback control such that a flow rate of a liquid supplied to the second nozzle becomes a set flow rate.

### Appendix 5

The chemical liquid supply device according to Appendix 5 is the chemical liquid supply device according to any one of Appendix 1 to Appendix 4, in which the control device controls the first valve, the second valve, and the third valve in the third mode, the fourth mode, and the fifth mode such that water having passed through the dilution water pipe is first supplied to the external device.

The chemical liquid supply device according to Appendix 5 may supply water passing through the dilution water pipe to the external device before the chemical liquid, in the case of the control device operating in the third mode, the fourth mode, and the fifth mode.

### Appendix 6

The chemical liquid supply device according to Appendix 6 is the chemical liquid supply device according to Appendix 1, and includes: a first chemical liquid control device attached to the first chemical liquid pipe and configured to perform feedback control such that a flow rate of the first chemical liquid supplied to the junction point becomes a set flow rate; a fourth valve that controls supplying of the first chemical liquid to the first chemical liquid control device; and a fifth valve that controls supplying of water to the first chemical liquid control device. The control device controls the fourth valve and the fifth valve such that when cleaning of the first chemical liquid pipe is started, the fourth valve is closed, and the fifth valve is opened after a first delay time from the closing of the fourth valve.

The chemical liquid supply device according to Appendix 6 may clean the inside of the first chemical liquid pipe and the inside of the cleaning chemical liquid supply pipe with water. Further, this chemical liquid supply device may suppress the first chemical liquid control device from causing a pressure upper limit error when cleaning of the first chemical liquid pipe starts.

### Appendix 7

The chemical liquid supply device according to Appendix 7 is the chemical liquid supply device according to Appendix 6, in which the control device controls the fourth valve and the fifth valve such that when cleaning of the first chemical liquid pipe is completed, the fifth valve is closed, and the fourth valve is opened after a second delay time from the closing of the fifth valve.

The chemical liquid supply device according to Appendix 7 may suppress the first chemical liquid control device from causing a pressure upper limit error when cleaning of the first chemical liquid pipe is completed.

### Appendix 8

The chemical liquid supply device according to Appendix 8 is the chemical liquid supply device according to Appendix 7, and includes: a second chemical liquid control device attached to the second chemical liquid pipe and configured to perform feedback control such that a flow rate of the second chemical liquid supplied to the junction point becomes a set flow rate; a sixth valve that controls supplying of the second chemical liquid to the second chemical liquid control device; and a seventh valve that controls supplying of water to the second chemical liquid control device. the control device controls the sixth valve and the seventh valve such that when cleaning of the second chemical liquid pipe is started, the sixth valve is closed, and the seventh valve is opened after a third delay time from the closing of the sixth valve, and when cleaning of the second chemical liquid pipe is completed, the seventh valve is closed, and the sixth valve is opened after a fourth delay time from the closing of the seventh valve.

The chemical liquid supply device according to Appendix 8 may clean the inside of the second chemical liquid pipe and the inside of the cleaning chemical liquid supply pipe with water. Further, this chemical liquid supply device may suppress the second chemical liquid control device from causing a pressure upper limit error when cleaning of the second chemical liquid pipe starts. Furthermore, this chemical liquid supply device may suppress the second chemical liquid control device from causing a pressure upper limit error when cleaning of the second chemical liquid pipe is completed.

### Appendix 9

The cleaning system according to Appendix 9 is a cleaning system, and includes: the chemical liquid supply device according to Appendix 3; and a substrate cleaning device for cleaning a substrate. The substrate cleaning device has the first nozzle and the second nozzle. The first nozzle is configured to supply the supply liquid to a first surface of the substrate, and the second nozzle is configured to supply the supply liquid to a second surface on a back side of the first surface of the substrate.

In the cleaning system according to Appendix 9, the chemical liquid supply device may also supply, to the substrate cleaning device, liquids other than the cleaning liquid obtained by diluting any two types of chemical liquids with pure water.

### Appendix 10

The liquid supply method according to Appendix 10 is a liquid supply method using the chemical liquid supply device according to any one of Appendices 1 to 8, and includes: a process in which the chemical liquid supply device supplies at least one of the first chemical liquid, the second chemical liquid, the first cleaning chemical liquid, the second cleaning chemical liquid, and the third cleaning chemical liquid to the external device.

The liquid supply method according to Appendix 10 may also supply, to the external device, liquids other than the cleaning liquid obtained by diluting any two types of chemical liquids with pure water.

The disclosure has described the embodiments and their respective modification examples, but it goes without saying that the above-mentioned examples are intended to facilitate understanding of the disclosure and do not limit the disclosure. The disclosure may be appropriately modified and improved within the scope that does not deviate from its spirit, and equivalents thereof are included in the disclosure. Further, any combination or omission of the components described in the claims and specification is possible within the range that may solve at least a part of the above-mentioned problems or within the range that may provide at least a part of the effects.

What is claimed is:

1. A chemical liquid supply device for supplying a supply liquid to an external device, the chemical liquid supply device comprising:
a junction point;
a dilution water pipe for supplying water to the junction point;
a first chemical liquid pipe for supplying a first chemical liquid to the junction point;
a second chemical liquid pipe for supplying a second chemical liquid to the junction point;
a first valve attached to the dilution water pipe;
a second valve attached to the first chemical liquid pipe;
a third valve attached to the second chemical liquid pipe;
a cleaning chemical liquid supply pipe located downstream of the junction point, for supplying the supply liquid to the external device; and
a control device operable in a first mode, a second mode, a third mode, a fourth mode, and a fifth mode,
wherein the control device controls the first valve, the second valve, and the third valve such that
in the first mode, only the first chemical liquid is supplied to the external device as the supply liquid,
in the second mode, only the second chemical liquid is supplied to the external device as the supply liquid,
in the third mode, a first cleaning chemical liquid formed by mixing the first chemical liquid and the water is supplied to the external device as the supply liquid,
in the fourth mode, a second cleaning chemical liquid formed by mixing the second chemical liquid and the water is supplied to the external device as the supply liquid, and
in the fifth mode, a third cleaning chemical liquid formed by mixing the first chemical liquid, the second chemical liquid, and the water is supplied to the external device as the supply liquid.

2. The chemical liquid supply device according to claim 1, comprising:
a dilution water control device attached to the dilution water pipe and configured to perform feedback control such that a flow rate of water supplied to the junction point becomes a set flow rate;
a first chemical liquid control device attached to the first chemical liquid pipe and configured to perform feedback control such that a flow rate of the first chemical liquid supplied to the junction point becomes a set flow rate; and
a second chemical liquid control device attached to the second chemical liquid pipe and configured to perform feedback control such that a flow rate of the second chemical liquid supplied to the junction point becomes a set flow rate.

3. The chemical liquid supply device according to claim 1, wherein
the cleaning chemical liquid supply pipe has
an upstream pipe constituting a flow path from the junction point to a branch point,
a first pipe constituting a flow path from the branch point to a first nozzle, and
a second pipe constituting a flow path from the branch point to a second nozzle.

4. The chemical liquid supply device according to claim 3, comprising:
a first supply amount control device attached to the first pipe and configured to perform feedback control such that a flow rate of a liquid supplied to the first nozzle becomes a set flow rate; and
a second supply amount control device attached to the second pipe and configured to perform feedback control such that a flow rate of a liquid supplied to the second nozzle becomes a set flow rate.

5. The chemical liquid supply device according to claim 1, wherein
the control device controls the first valve, the second valve, and the third valve in the third mode, the fourth mode, and the fifth mode such that water having passed through the dilution water pipe is first supplied to the external device.

6. The chemical liquid supply device according to claim 1, comprising:
a first chemical liquid control device attached to the first chemical liquid pipe and configured to perform feedback control such that a flow rate of the first chemical liquid supplied to the junction point becomes a set flow rate;
a fourth valve that controls supplying of the first chemical liquid to the first chemical liquid control device; and
a fifth valve that controls supplying of water to the first chemical liquid control device,
wherein the control device controls the fourth valve and the fifth valve such that
when cleaning of the first chemical liquid pipe is started, the fourth valve is closed, and the fifth valve is opened after a first delay time from the closing of the fourth valve.

7. The chemical liquid supply device according to claim 6, wherein
the control device controls the fourth valve and the fifth valve such that
when cleaning of the first chemical liquid pipe is completed, the fifth valve is closed, and the fourth valve is opened after a second delay time from the closing of the fifth valve.

8. The chemical liquid supply device according to claim 7, comprising:
a second chemical liquid control device attached to the second chemical liquid pipe and configured to perform feedback control such that a flow rate of the second chemical liquid supplied to the junction point becomes a set flow rate;
a sixth valve that controls supplying of the second chemical liquid to the second chemical liquid control device; and
a seventh valve that controls supplying of water to the second chemical liquid control device,
wherein the control device controls the sixth valve and the seventh valve such that
when cleaning of the second chemical liquid pipe is started, the sixth valve is closed, and the seventh valve is opened after a third delay time from the closing of the sixth valve, and
when cleaning of the second chemical liquid pipe is completed, the seventh valve is closed, and the sixth valve is opened after a fourth delay time from the closing of the seventh valve.

9. A cleaning system, the cleaning system comprising:
the chemical liquid supply device according to claim 3; and
a substrate cleaning device for cleaning a substrate,
wherein the substrate cleaning device has the first nozzle and the second nozzle,
the first nozzle is configured to supply the supply liquid to a first surface of the substrate, and
the second nozzle is configured to supply the supply liquid to a second surface on a back side of the first surface of the substrate.

10. A liquid supply method using the chemical liquid supply device according to claim 1, the liquid supply method comprising:
a process in which the chemical liquid supply device supplies at least one of the first chemical liquid, the second chemical liquid, the first cleaning chemical liquid, the second cleaning chemical liquid, and the third cleaning chemical liquid to the external device.
